(19) United States
(12) Patent Application Publication
(10) Pub. No.: US 2014/0083535 A1
(43) Pub. Date: Mar. 27, 2014

(54) FITTING FOR AN INTAKE LINE

(71) Applicant: Mathys Van Ryswyk, Edwardsville, IL (US)

(72) Inventor: Mathys Van Ryswyk, Edwardsville, IL (US)

(21) Appl. No.: 14/022,724

(22) Filed: Sep. 10, 2013

Related U.S. Application Data
(60) Provisional application No. 61/705,783, filed on Sep. 26, 2012.

(51) Int. Cl. F17D 1/14

(52) U.S. Cl. CPC F17D 1/14
USPC 137/565.01; 137/15.01; 285/405

(57) ABSTRACT

A fitting for an intake line is provided. The fitting includes a connector piece having an intake end and a foot valve end. The intake end couples to an intake line and the foot valve end couples to a foot valve. A flange circumvents the connector piece. The intake end extends from an intake side of the flange. The foot valve end extends from a foot valve side of the flange.

### CROSS-REFERENCE TO RELATED APPLICATIONS

This application is a non-provisional patent application of U.S. Provisional Patent Application Ser. No. 61/705,783 having a filing date of Sep. 26, 2012 and titled “FITTING FOR AN INTAKE LINE”, which is herein incorporated in its entirety.

### BACKGROUND OF THE DISCLOSED EMBODIMENTS

The disclosed embodiments relate to an intake valve, and in particular, a fitting for an intake valve.

Irrigation systems that utilize water from a lake or other natural water source are well known. Generally, a pump is positioned outside of the lake and an intake valve extends into the lake to pump water therefrom. A foot valve is positioned on the end of the intake line and submerged into the water. Water is pumped from the lake through the foot valve and the intake line to provide irrigation water for landscaping. However, not all intake lines effectively pump water from the lake. In particular, mud and other debris within the lake may clog the foot valve thereby causing the flow of water through the intake line to be limited or entirely blocked.

Some known foot valves include screens to prevent larger debris from being drawn into the pump. Unfortunately, the screens are still susceptible to being clogged with mud and leaves, thereby blocking the flow of water. Other foot valves are lifted up from the lake floor; however, many of these designs position the foot valve out of the water if the water level in the lake drops. Other foot valves are lifted using buoys are even plastic bottles. Such systems are undesirable as they are unsightly. Additionally, some foot valves sit in a base that lifts the foot valve off the lake floor. Unfortunately, these bases may easily become clogged with debris and are typically ineffective. Also, many guards for foot valves are permanent and cannot be removed during the winter season and/or for maintenance.

A need remains for an intake line fitting that lifts the foot valve off the floor of the lake, while directing debris away from the foot valve.

### SUMMARY OF THE DISCLOSED EMBODIMENTS

In one aspect, a fitting for an intake line is provided. The fitting includes a connector piece having an intake end and a foot valve end. The intake end couples to an intake line and the foot valve end couples to a foot valve. A flange circumvents the connector piece. The intake end extends from an intake side of the flange. The foot valve end extends from a foot valve side of the flange. In one embodiment, an outer rim of the flange extends outward in the direction of the foot valve side of the flange. The foot valve end is circumvented by the flange, and the foot valve is circumvented by the flange. The foot valve is spaced from the outer rim of the flange. The outer rim is positioned radially outward from the foot valve. In one embodiment, the flange has at least one of a spherical shape, a conical shape, or a cylindrical shape. In one embodiment, the flange extends substantially perpendicular to an axis of the connector piece.

In one aspect, a method of blocking debris in an intake line is provided. The method includes coupling the intake end of a connector piece to an intake line, and coupling a foot valve end of a connector piece to a foot valve. The connector piece is circumvented with a flange so that the intake end extends from an intake side of the flange and the foot valve end extends from a foot valve side of the flange.

Further areas of applicability of the disclosed embodiments will become apparent from the detailed description provided hereinafter. It should be understood that the detailed description and specific examples, while indicating the preferred embodiment, are intended for purposes of illustration only and are not intended to limit the scope of the disclosed embodiments.

### BRIEF DESCRIPTION OF THE DRAWINGS

The disclosed embodiments will become more fully understood from the detailed description and the accompanying drawings, wherein:

FIG. 1 is a schematic view of an intake line for a pump having a fitting around the foot valve.

FIG. 2 is an exploded view of the intake line, fitting, and foot valve shown in FIG. 1.

FIG. 3 is a side view of a spherical fitting formed in accordance with an embodiment.

FIG. 4 is a cross-sectional view of the fitting shown in FIG. 3.

FIG. 5 is a front view of the fitting shown in FIG. 3.

FIG. 6 is a side view of a conical fitting formed in accordance with an embodiment.

FIG. 7 is a cross-sectional view of the fitting shown in FIG. 6.

FIG. 8 is a front view of the fitting shown in FIG. 6.

FIG. 9 is a side view of a cylindrical fitting formed in accordance with an embodiment.

FIG. 10 is a front view of the fitting shown in FIG. 9.

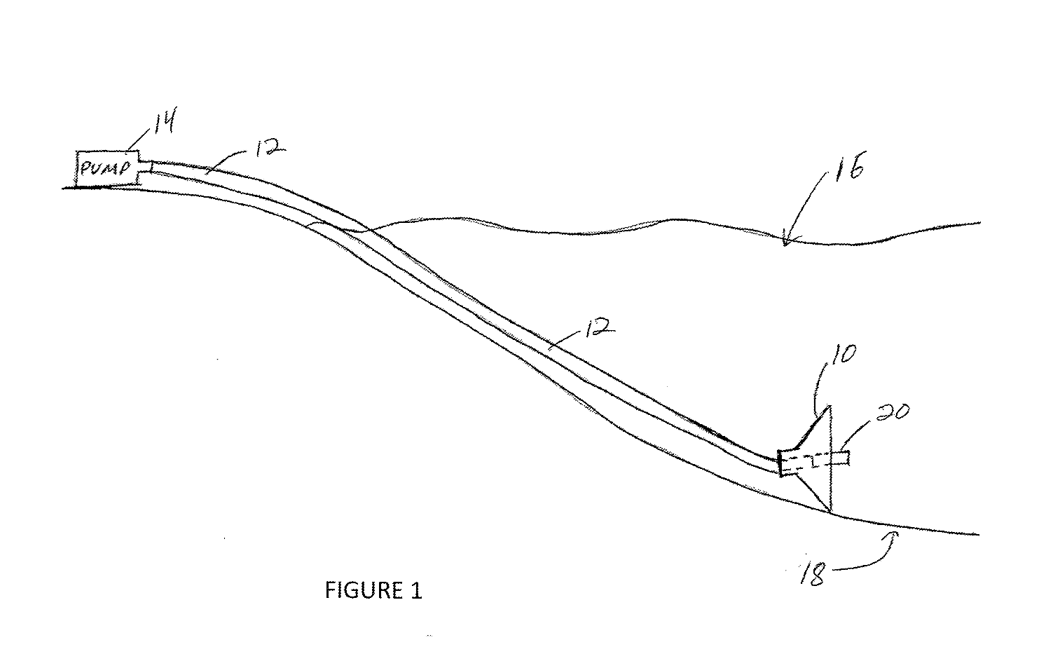

### DETAILED DESCRIPTION OF THE DISCLOSED EMBODIMENTS

The following description of the preferred embodiment(s) is merely exemplary in nature and is in no way intended to limit the disclosed embodiments, their applications, or uses.

The disclosed embodiments provide a fitting 10 for an intake line 12, wherein the intake line 12 is joined to a pump 14 to draw water from a lake 16 or other natural body of water for irrigation purposes. In particular, the water drawn from the lake 16 may be utilized for landscaping or the like. The pump 14 is positioned outside of the lake 16 and joined to the intake line 12, which extends along the floor 18 of the lake 16. A foot valve 20 is positioned at an end of the intake line 12 and submerged in the water of the lake 16. The fitting 10 for the intake line 12 is removable from the lake 16 so that the entire intake line 12 may be removed for maintenance and/or during winter season.

In the exemplary embodiment, the fitting 10 is positioned between the intake line 12 and the foot valve 20. The fitting 10 is designed to position the foot valve 20 off the floor 18 of the lake 16 to prevent the foot valve 20 from becoming clogged with mud, leaves, or other debris. A flange 22 of the fitting 10 has an outer rim 24 that is positioned radially outward from the foot valve 20, so that the foot valve 20 is centered with respect to the fitting 10. The flange 22 lifts the foot valve 20 from the floor 18 of the lake 16 and directs debris away from the foot valve 20.

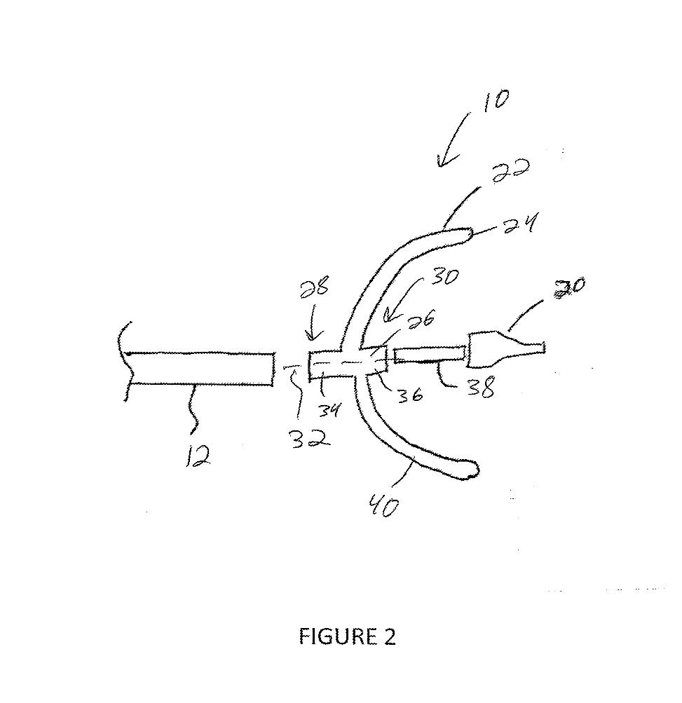

In the illustrated embodiment, the fitting 10 includes a connector piece 26 and the flange 22. In the exemplary embodiment, the connector piece 26 is a hollow cylindrical tube. The flange 22 includes an intake side 28 and a foot valve side 30. The intake line 12 joins to the fitting 10 on the intake side 28 of the flange 22 and the foot valve 20 joins to the fitting 10 on the foot valve side 30 of the flange 22. The foot valve 20 extends axially from an axis 32 of the connector piece 26. The flange 22 circumvents the connector piece 26 and an intake end 34 of the connector piece 26 extends from the intake side 28 of the flange 22 and a foot valve end 36 of the connector piece 26 extends from the foot valve side 30 of the flange 22. The intake line 12 is joined to the intake end 34 of the connector piece 26 and the foot valve 20 is joined to the foot valve end 36 of the connector piece 26. As shown in FIG. 2, the foot valve 20 is joined to the foot valve end 36 with a pipe nipple 38.

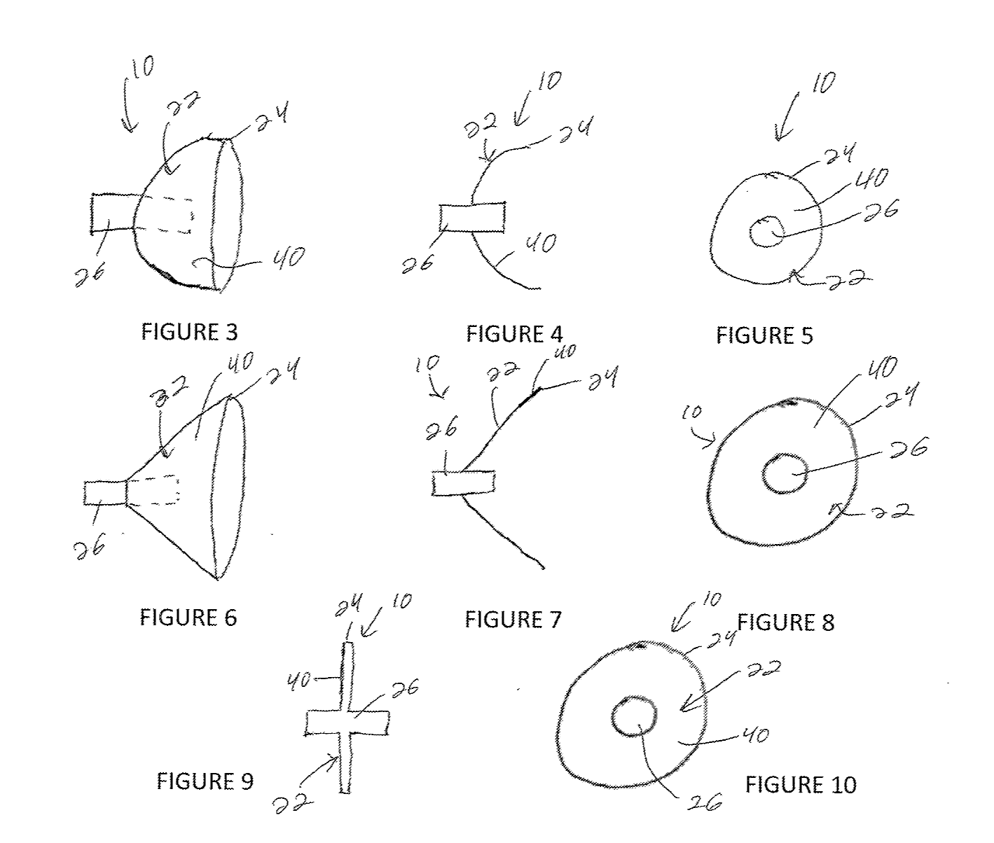

In the embodiments shown in FIGS. 3-8, the outer rim 24 of the flange 22 extends outward in the direction of the foot valve side 30 of the flange 22. A sidewall 40 extends between the connector piece 26 and the outer rim 24. In FIGS. 3-5, the sidewall 40 is hyperbolic in shape giving the flange 22 a substantially spherical shape. In FIGS. 6-8, the sidewall 40 is straight and extends from the connector piece 26 at an angle with respect to a connector piece axis 32, thereby giving the flange 22 a conical shape. The outer rim 24 is radially spaced from the foot valve 20 and the foot valve 20 is centered with respect to the outer rim 24 and the flange 22. The flange 22 circumvents the foot valve 20. The sloped shape of the flange 22 in FIGS. 3-8 facilitates directing debris away from the foot valve 20. In particular, there is no surface adjacent the foot valve 20 where debris can gather. In one embodiment, a screen (not shown) may be extended across the outer rim 24 of the flange 22. In such an embodiment, the foot valve 20 is positioned within an enclosure formed by the flange 22 and the screen.

In the embodiments shown in FIGS. 9 and 10, the sidewall 40 of the flange 22 extends radially from the connector piece 26. The sidewall 40 extends substantially perpendicular to the axis 32 of the connector piece 26 so that the outer rim 24 of the flange 22 circumvents the connector piece 26. In this embodiment, the flange 22 has a cylindrical shape. The foot valve end 30, and subsequently the foot valve 20, extends outward from the flange 22 along the axis 32 of the connector piece 26. The perpendicular angle of the flange 22 eliminates surfaces around the foot valve 20 where debris can gather. Accordingly, the flange 22 directs the debris away from the foot valve 20.

The disclosed embodiments provide an intake line fitting that lifts the foot valve off the floor of the lake, while directing debris away from the foot valve. The disclosed embodiments also provide a fitting that lifts the foot valve off the floor of the lake, while keeping the foot valve submerged when the water levels in the lake are low. Moreover, the fitting is easily removable from the intake line and foot valve. Accordingly, the fitting may be removed for maintenance and/or for winter season.

In one embodiment, a method of blocking debris in an intake line is provided. The method includes coupling the intake end of a connector piece to an intake line, and coupling a foot valve end of a connector piece to a foot valve. The connector piece is circumvented with a flange so that the intake end extends from an intake side of the flange and the foot valve end extends from a foot valve side of the flange. In one embodiment an outer rim of the flange is extended outward in the direction of the foot valve side of the flange. The foot valve end may be circumvented with the flange. The foot valve may be circumvented with the flange. The foot valve may be spaced from the outer rim of the flange so that the outer rim is positioned radially outward from the foot valve. The flange may have a spherical shape or a conical shape. In one embodiment, the flange extends substantially perpendicular to an axis of the connector piece. The flange may have a cylindrical shape.

The embodiments were chosen and described to best explain the principles of the disclosed embodiments and its practical application to persons who are skilled in the art. As various modifications could be made to the exemplary embodiments, as described above with reference to the corresponding illustrations, without departing from the scope of the disclosed embodiments, it is intended that all matter contained in the foregoing description and shown in the accompanying drawings shall be interpreted as illustrative rather than limiting. Thus, the breadth and scope of the disclosed embodiments should not be limited by any of the above-described exemplary embodiments, but should be defined only in accordance with the following claims appended hereto and their equivalents.

What is claimed is:

1. A fitting for an intake line comprising:
a connector piece having an intake end and a foot valve end, the intake end coupling to an intake line, and the foot valve end coupling to a foot valve; and
a flange circumventing the connector piece, the intake end extending from an intake side of the flange, and the foot valve end extending from a foot valve side of the flange.

2. The fitting of claim 1, wherein an outer rim of the flange extends outward in the direction of the foot valve side of the flange.

3. The fitting of claim 2, wherein the foot valve end is circumvented by the flange.

4. The fitting of claim 2, wherein the foot valve is circumvented by the flange.

5. The fitting of claim 4, wherein the foot valve is spaced from the outer rim of the flange, the outer rim being positioned radially outward from the foot valve.

6. The fitting of claim 2, wherein the flange has a spherical shape.

7. The fitting of claim 2, wherein the flange has a conical shape.

8. The fitting of claim 1, wherein the flange extends substantially perpendicular to an axis of the connector piece.

9. The fitting of claim 8, wherein the flange has a cylindrical shape.

10. A method of blocking debris in an intake line, the method comprising:
coupling the intake end of a connector piece to an intake line;
coupling a foot valve end of a connector piece to a foot valve; and
circumventing the connector piece with a flange so that the intake end extends from an intake side of the flange and the foot valve end extends from a foot valve side of the flange.

11. The method of claim 8 further comprising extending an outer rim of the flange outward in the direction of the foot valve side of the flange.

12. The method of claim 11 further comprising circumventing the foot valve end with the flange.

13. The method of claim 11, further comprising circumventing the foot valve with the flange.

14. The method of claim 13 further comprising spacing the foot valve from the outer rim of the flange so that the outer rim is positioned radially outward from the foot valve.

15. The method of claim 11 further comprising circumventing the connector piece with a flange having a spherical shape.

16. The method of claim 11 further comprising circumventing the connector piece with a flange having a conical shape.

17. The method of claim 10 further comprising extending the flange substantially perpendicular to an axis of the connector piece.

18. The method of claim 17 further comprising circumventing the connector piece with a flange having a cylindrical shape.

19. An apparatus for irrigation comprising:
an intake line;
a pump fluidly coupled to a first end of the intake line;
a fitting fluidly coupled to a second end of the intake line, the fitting comprising:
a connector piece having an intake end and a foot valve end, the intake end coupled to the intake line, and the foot valve end coupled to a foot valve; and
a flange circumventing the connector piece, the intake end extending from an intake side of the flange, and the foot valve end extending from a foot valve side of the flange.

20. The apparatus of claim 19, wherein the foot valve is centered with respect to an outer rim of the flange.
